(19) United States
(12) Patent Application Publication
(10) Pub. No.: US 2016/0367895 A1
(43) Pub. Date: Dec. 22, 2016

(54) SYSTEM AND METHOD OF USING SOFTWARE GAMES TO ENCOURAGE USE OF IT CONFIGURATION MANAGEMENT SYSTEMS

(71) Applicant: Peter Beasley, Dallas, TX (US)

(72) Inventor: Peter Beasley, Dallas, TX (US)

(21) Appl. No.: 14/222,587

(22) Filed: Mar. 22, 2014

Related U.S. Application Data
(63) Continuation-in-part of application No. 12/665,545, filed on Dec. 18, 2009, now abandoned.
(60) Provisional application No. 61/852,736, filed on Mar. 21, 2013.

(51) Int. Cl. A63F 13/30; A63F 13/828

(52) U.S. Cl. CPC A63F 13/30; A63F 13/828

(57) ABSTRACT

This invention teaches using gaming technology to motivate the use of IT change management systems. More specifically, games like Fantasy IT, routines that mimic the fun and encouragement of the bowling red pin game, and software mechanics that provide virtual currency for IT change management are taught through this disclosure.

### CROSS-REFERENCE TO RELATED APPLICATIONS

This is a non-provisional Continuation application, in part, under CFR 1.53(b) and claims priority from copendent U.S. patent application Ser. No. 12/665,545 entitled “System and method of using gaming software technology to motivate the use of business software”, filed Jan. 6, 2010, which claimed priority from U.S. Provisional Patent Application 61/204,266 entitled “System and method to use gaming technology to enhance network systems management solutions”, filed Jan. 6, 2009, and claims priority to U.S. Provisional Patent Application 61/852,736 entitled “System and method to use gaming technology to encourage network systems management use”, filed Mar. 21, 2013 all which are filed by Inventor Peter Beasley, which are both incorporated by reference, in their entirety.

### TECHNICAL FIELD OF THE INVENTION

The present invention relates generally to gaming software.

### Problem Statement

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Computer and/or telecommunications networks include a plurality of personal computers, workstations, storage servers, database servers, applications, databases, network-attached devices, routers, firewalls, network interfaces and other devices, logical components like IP addresses, DNS addresses, and firewall rules, all interconnected by wired, wireless or hierarchical interconnection networks. The phrase “IT change management” refers to the management of planned changes to any of these components, in enterprise data networks or telecommunications networks. Within this description, the words “IT downtime” refer to loss or degraded performance to both enterprise data networks and telecommunications networks.

An object of the present invention is to overcome the tendency that business software, network systems management systems—CMDB systems in particular, have the drawback that if people do not use the system, the system can fall into disuse.

Another object of the invention is to provide systems and methods to add a fun game to a network system management (NSM) system.

Another object of the invention is to provide systems and methods to add a fun game to a NSM system in a manner that does not detract from the use of the NSM system.

Another object of the invention is to provide systems and methods to add a fun game to a NSM system that includes the element of chance.

Another object of the invention is to provide systems and methods to add a fun game to a NSM system that provides social competitiveness.

These and other objects of the invention are accomplished according to various embodiments of the invention, including one embodiment in the form of the Red Pin game.

Another object of the invention is to provide a method for creating the Fantasy IT game in the NSM system.

Other objects and advantages exist for the present invention.

The invention creates the game called the Red Pin game to IT change management. This game is often played at bowling alleys, but no one of ordinary skill in network management systems would apply this game to business software. The game at bowling alleys randomly select the head pin to be colored red, and if the bowler gets a strike, the bowler wins a prize. Similarly, the present invention selects an IT change to be a Red Pin Change, and if the IT professional completes this change with a 100% efficiency, the IT professional is awarded points. As change management continues within the IT departments, IT professionals periodically acquire points based on the chance that their IT change may be a Red Pin change and also due to their skill at completing an IT change perfectly.

The invention also creates the game called Fantasy IT to IT change management. This game is often played related to sports, i.e. Fantasy Football, but no one of ordinary skill in network management systems would apply this game to business software. In essence, the individuals who play the Red Pin game and obtain points can organize themselves in teams. The team selections can be done at any time or during pre-defined periods of time, e.g. the beginning of the summer and winter, called Draft Periods. Points earned in IT change management by the various individuals on the teams will be summed to create team scores. The team scores are shown on a leaderboard.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 is a flowchart of an embodiment of a method according to the invention.

FIG. 2 depicts a schematic diagram of a hardware system according to an embodiment of the invention.

FIG. 3 depicts a schematic diagram of a system according to an embodiment of the invention.

FIG. 4 illustrates a graphical user interface according to an embodiment of the invention, illustrating Red Pin changes.

FIG. 5 illustrates a graphical user interface according to an embodiment of the invention, illustrating setting up Red Pin selection.

FIG. 6 illustrates a graphical user interface according to an embodiment of the invention, illustrating the display of the Leaderboard.

FIG. 7 illustrates a graphical user interface according to an embodiment of the invention, illustrating editing a Red Pin change.

FIG. 8 illustrates a graphical user interface according to an embodiment of the invention, illustrating grading a Red Pin change.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in .sctn.112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Unless otherwise indicated, acronyms used have the ordinary meaning of those acronyms in the context presented, and are readily understood by those of ordinary skill in the art. Words and phrases are to be given their ordinary plain meaning unless indicated otherwise.

### Invention Overview

The invention teaches systems and methods to increase the adoption and use of business software, such as network systems management solutions, including configuration management database solutions.

The Information Technology Infrastructure Library (ITIL®) was created to improve the management of distributed IT computer networks. This library defines a configuration management database (CMDB), which is a repository of various types of information about IT computer networks. Numerous software programs and patent applications have since been created to embody or define a CMBD. This includes products like Computer Associate's UniCenter, BMC Software's Remedy Asset Management, and FrontRange's ITSM and Patent Applications 20080263084, 20080244611, 20080005187, 20070203952, and 20060004875. Other products and patent applications exist too. These products though, as with other enterprise configuration management products, suffer from the likelihood of 1) disuse or 2) having inaccurate data. These two problems are interrelated.

When examined closer, CMDBs are electronic systems that have a significant level of information that is not auto-discoverable or populated electronically and therefore rely on IT technologists to manually enter a significant amount of data. CMDB implementations will not accomplish their intended goals unless IT professionals use the system. The lack of system use leads to a lack of critical data. The lack of critical data leads to data inaccuracies, which leads further to a lack of system use.

CMDB systems can fail if people do not use the system. The IT industry has faced this problem for years and many network systems management (NSM) implementations have failed due to a lack of system use. These failed implementations include asset management, change management, incident management and configuration management systems, alike. People tend not to use the system if it has inaccurate data. Likewise, if people do not use the system, it will have inaccurate data. Therefore, one key to being successful at NSM systems is to have a method that entices people to use the system.

What is needed is a method to influence the behavior of IT technologists such that they will use NSM systems, CMDB systems in particular. An innovation is needed that will encourage IT technologists to improve how they record information on the systems they manage and support. And this invention is applicable to almost any business software where the users may need encouragement to use.

My invention includes four (4) key components.

Fun—defined as a source of enjoyment, amusement, or pleasure—is one element of my invention to influence IT technologists to use NSM and CMDB solutions. Few people enjoy boredom. Likewise, many people do not like “documentation”. Adding fun to the process of IT system documentation takes away the monotony that many network systems management systems suffer. My invention employs finding a fun way to entice people to use a network systems management system. In particular, my invention employs the use of games as a fun method to encourage people to use CMDB solutions.

Games have a long history of providing enjoyment to people. Their popularity can be traced to the entertainment derived from social interaction which comes from the combination of competition and comradery inherent in game playing. Furthermore, games are useful in developing social cohesion and developing communities. I have determined that game play can be useful in modifying organizational behavior to adopt the concepts defined in the ITIL framework.

However, the addition of fun games to network systems management software cannot be employed in a manner that would detract from the business mission of the organization. Quite understandably, many companies or IT departments would not encourage their employees to play games during work hours. Game play cannot be allowed to interfere with business priorities.

A second component of my invention is to add gaming in a manner that supports but does not detract from the corporate mission.

Educational games, as an example, can be added to network systems management solutions as a method to encourage system use without interfering with business priorities. Businesses have an inherent mission to educate their employees on their internal policies and procedures and an education game that tests staff knowledge about IT procedures can help IT technologists learn. Still, the addition of the educational game should not detract from the use of the network management system; but rather encourage its use. Therefore, the added game cannot allow players to extend play, compete directly against each other, or simply play the game. The added game merely complements the use of the network systems management system, or a CMDB.

Most organizations have rules or procedures on how they manage their assets. In large organizations, these rules can be confusing or misunderstood by the group of people who use or support those assets. By using simple on-line testing of these rules and procedures, a NSM system can create a fun game. Playing the game within the NSM system helps people learn the organization's rules, but also entices people to use the asset management system. The underlying effect is that as more people use the system, the system will have more complete information.

A third element of my invention is for the added game to employ an element of chance. The unpredictability of games of chance increase excitement and minimize monotony. Again, the added game has the intent to minimize the boredom associated with IT system documentation and therefore an exciting, unpredictable game tends to hide the underlying monotony in using network system management systems.

Lastly, added games that provide social competitiveness can enhance the use of network systems management systems. Scoring of the game should be conducted in a manner that identifies who is winning as the game is played.

One embodiment that incorporates the elements of this invention creates the Red Pin game.

Another embodiment that incorporates the elements of this invention is the Fantasy IT Game.

### DESCRIPTION OF THE DRAWINGS

The present invention is described in relation to an electronic network systems management software system that multiple users access using distributed computers over a computer network, however this could be virtually any other business software system. In this environment, the present invention provides the description of an online electronic game which is added as a feature to the network systems management system. For purposes of explaining the present invention, an embodiment of the present invention is set forth, however other embodiments are described by the invention.

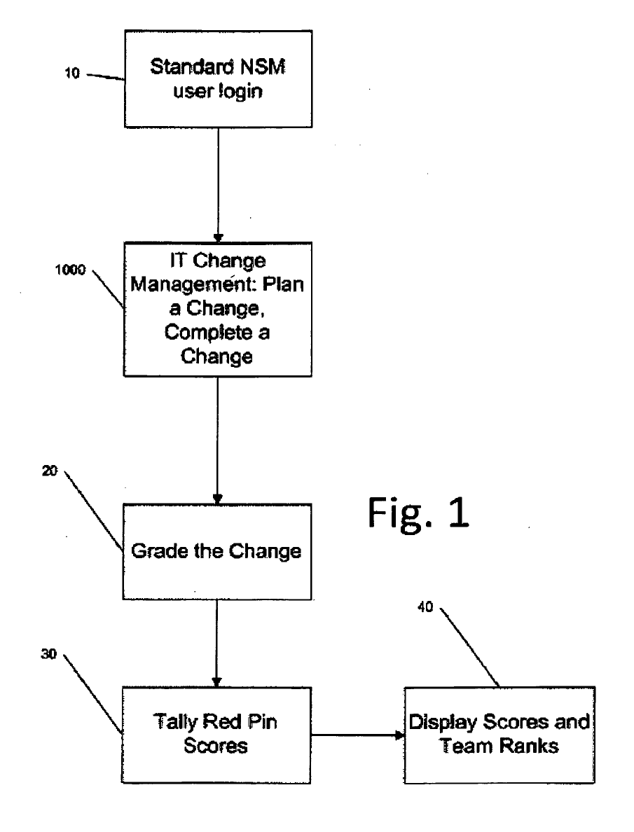

FIG. 1. is a flowchart illustrating an embodiment of the present invention, including the steps of NSM User Login 10, IT Change Management w/Red Pin Selection 1000, Grading of Changes 20, Tallying of Red Pin Scores 30, and Display of Scores and Team Ranks 40. As shown, the game associated with this invention is added to the existing operation of a NSM solution. This particular embodiment incorporates the game as part of the NSM system use for IT change management 1000. Other embodiments of this invention could insert the game between or as part of other NSM components.

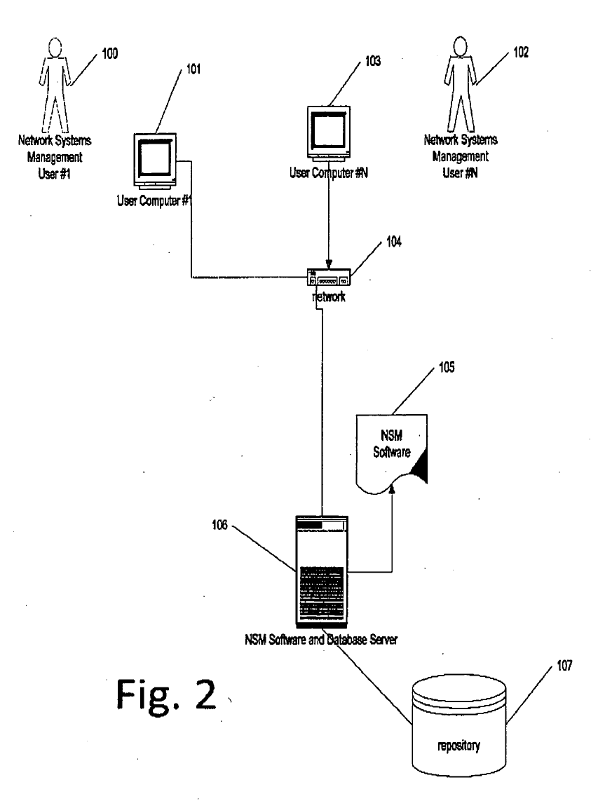

FIG. 2. depicts a schematic diagram of a hardware system according to an embodiment of the invention. The NSM software 105 operates on a server 106 and is accessed by multiple users 100, 102 using multiple computers 101, 103 across a computer network 104. The NSM software 105 relies on a database repository 107, which may be a configuration management database. The standard NSM login process (FIG. 1 10) is used to identify the particular user that plays the game. As described further, the database repository 107 will also be used to track the game score for each player.

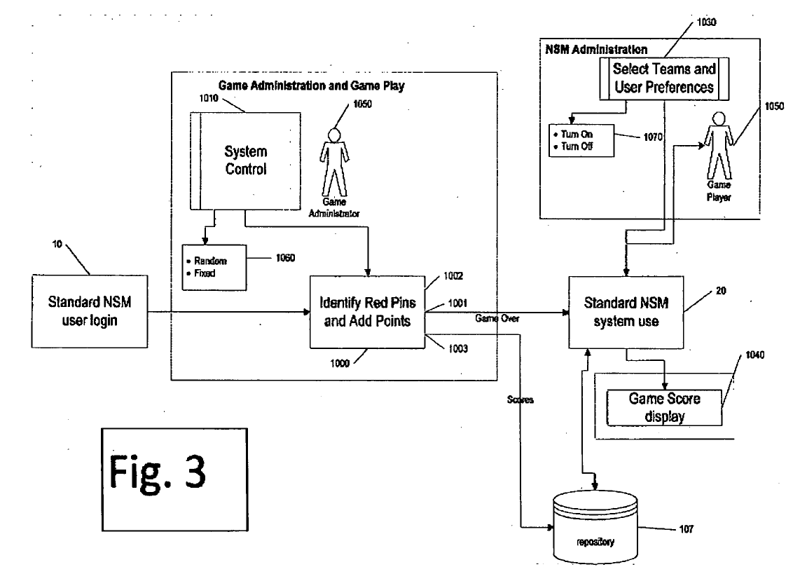

FIG. 3. depicts a schematic diagram of a system according to an embodiment of the invention. The elements of the invention which are added to the existing NSM application are illustrated in the shaded portions of the drawing.

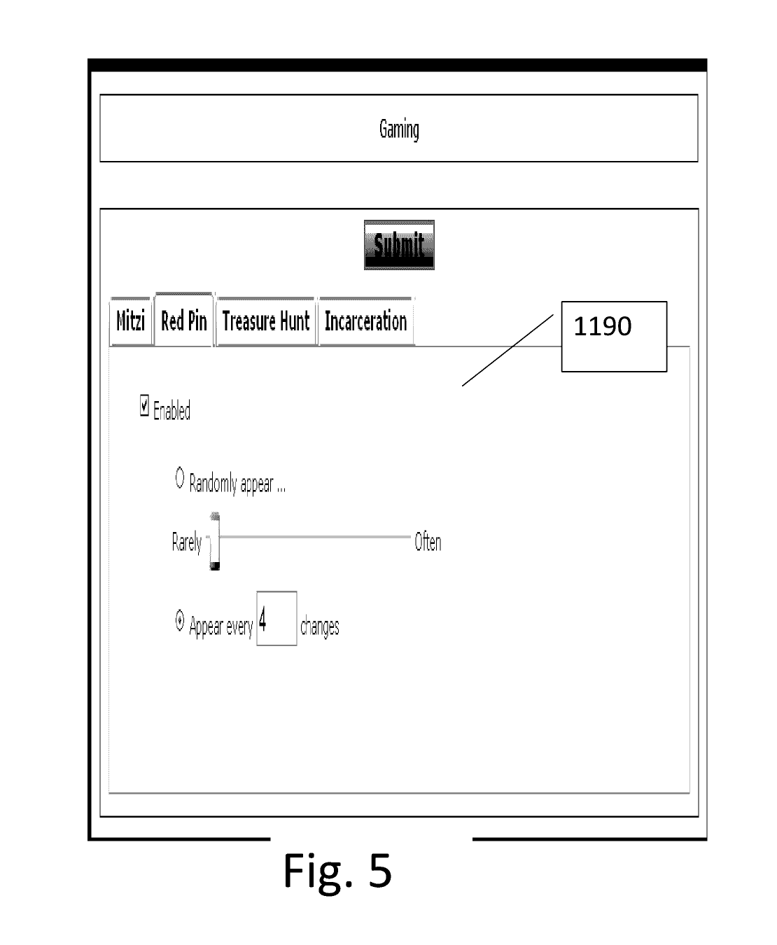

The standard administration portion of the NSM application is modified to allow an existing NSM system user to be flagged in the repository 107 as the Game Player 1050. Any NSM user who is flagged as a game administrator has the capability of manipulating the game Red Pin Game Control 1010. The System Control 1010 module is used to define game operation as either 1) Random pin selection, or 2) fixed pin selection (FIG. 5,1060). Additionally, the standard administration portion of the NSM application is modified to allow individual users to 1) Turn On or 2) Turn Off game play 1070, and to select teams, 1030.

As described earlier, Game Play 1000 cannot interfere with business use of the NSM application. When the game play is over 1001, application control is passed back to the NSM application, 20. There is no ability to just play the game.

As various NSM users play the game, scores are tallied 1000 and saved 1003 in the NSM database repository 107. The NSM application is modified to display the game winners 1040.

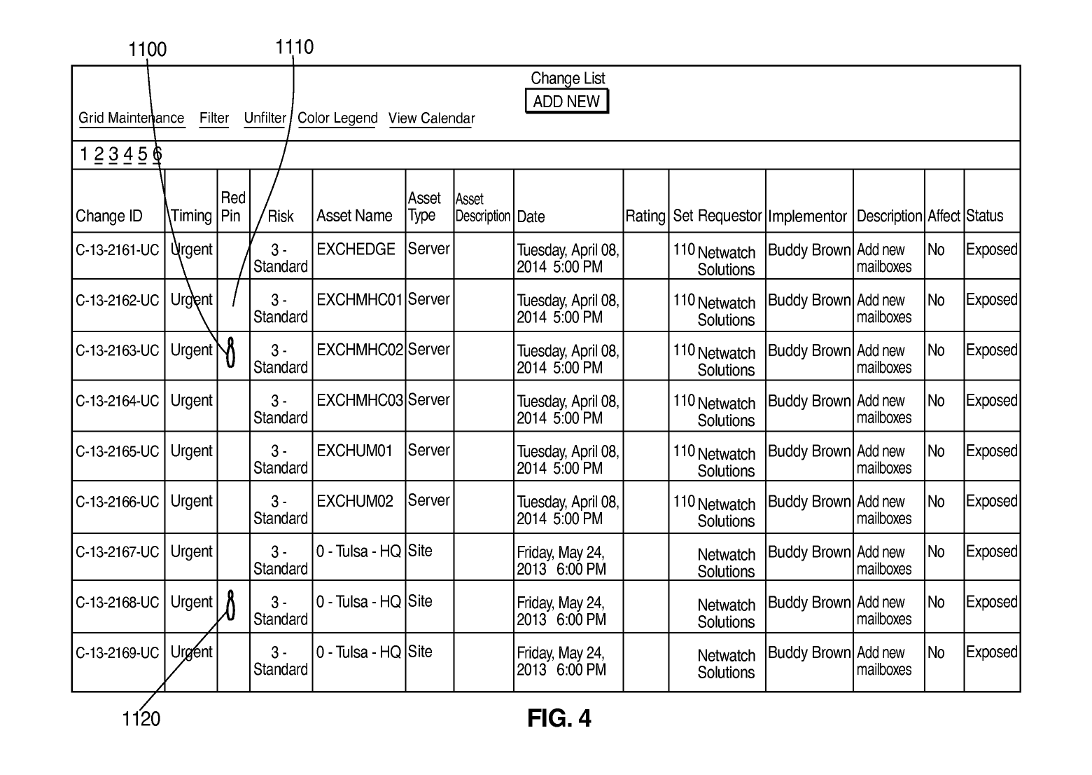

FIG. 4. illustrates how some changes are identified as Red Pin changes, 1120 and 1100, and other changes are not, 1110.

FIG. 5. illustrates how the Red Pin selection process can be done at random, or upon a fixed interval, 1190.

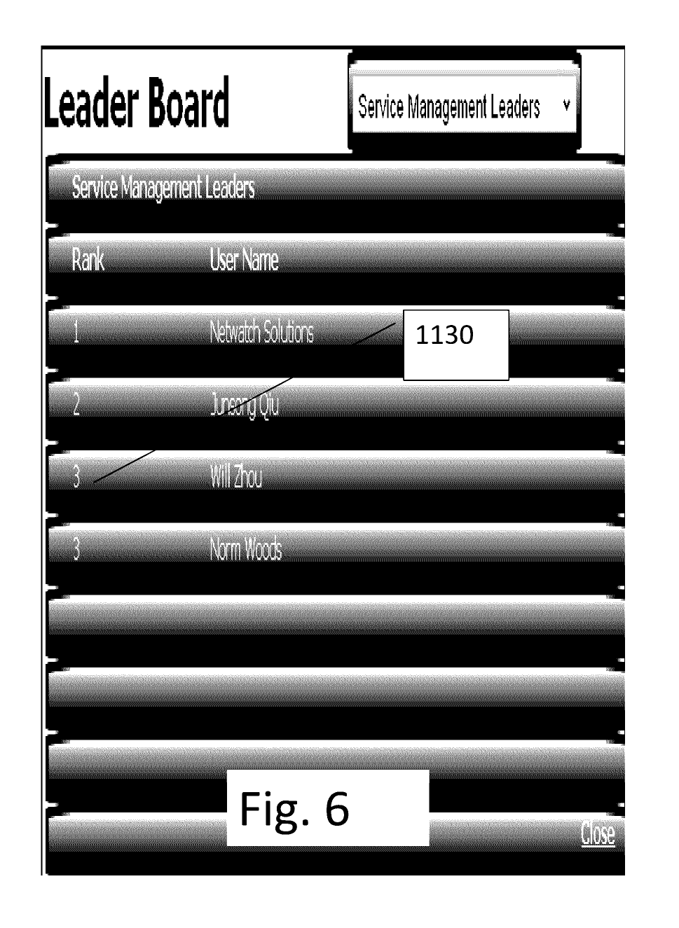

FIG. 6. illustrates a graphical user interface according to an embodiment of the invention, illustrating the Points Leaders, 1130. Selection of Points Leaders or Team Leaders can be displayed, as selected. In reality, the organization is the winner. By use of system, people are encouraged to do well on IT change management and also to document their IT changes. Also, the more people play the game, the more people use the system. The more people use the system, the more complete is the system data.

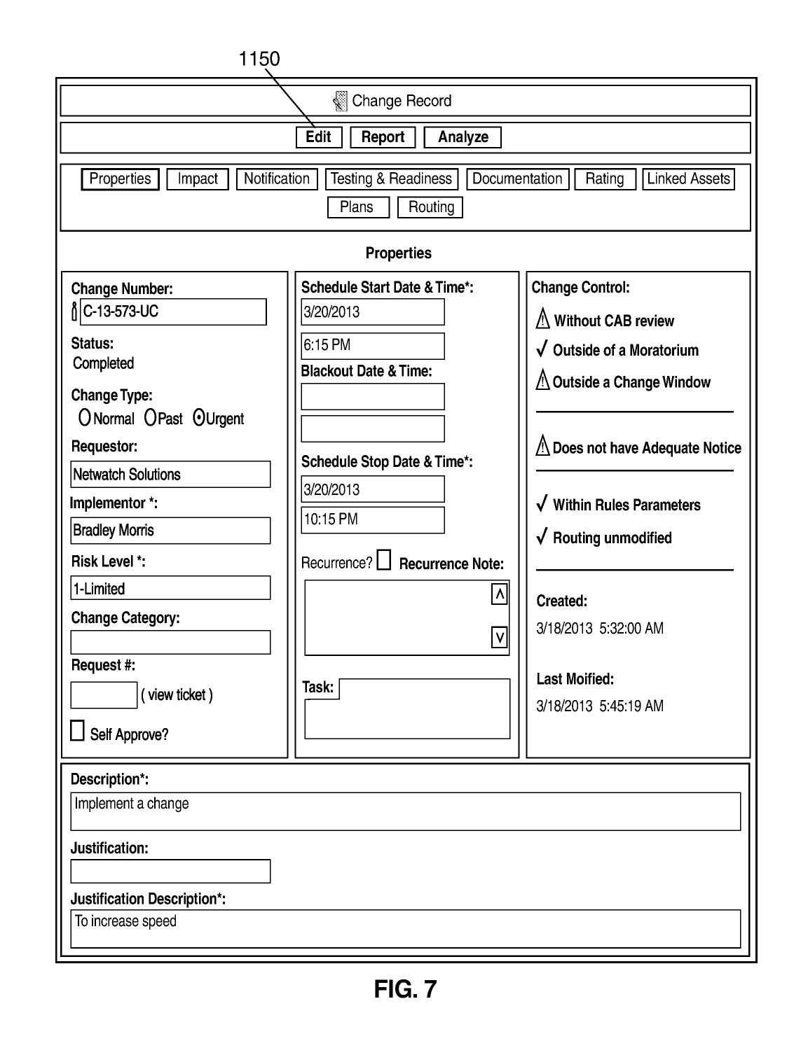

FIG. 7. illustrates a graphical user interface according to an embodiment of the invention, showing how a Red Pin change can be edited, 1150.

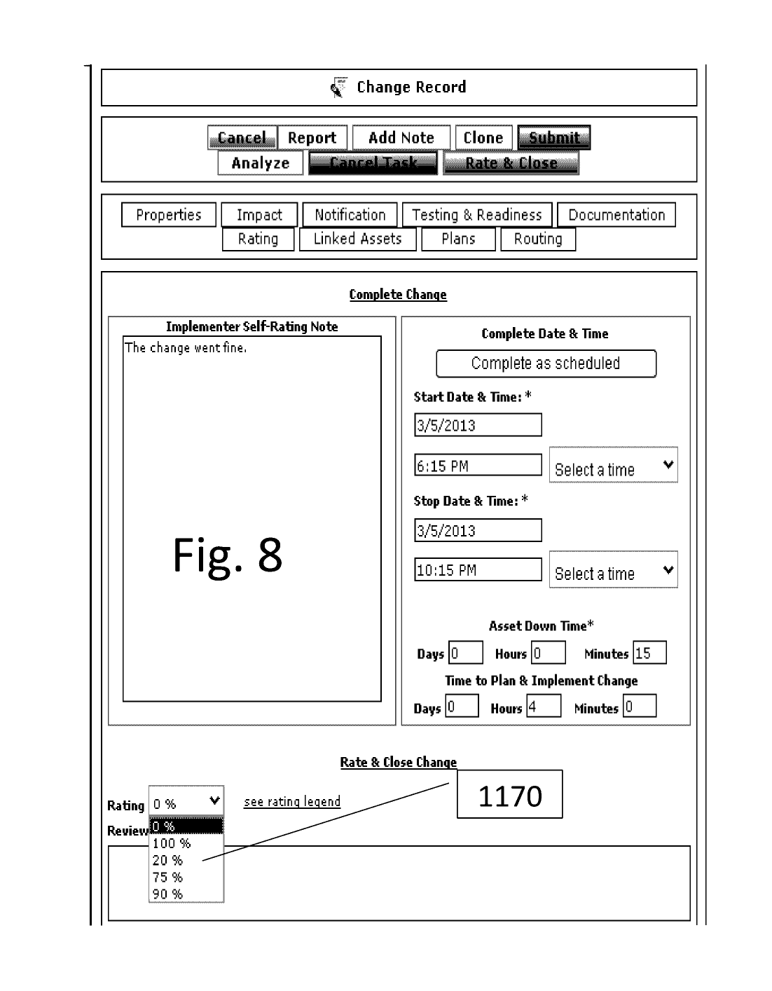

FIG. 8. illustrates a graphical user interface according to an embodiment of the invention, showing how a Red Pin change can be graded, 1170.

As described in this invention, other games could be incorporated into the network systems management software. Like giving points for doing good at IT change management, points could be lost for performing poor at IT change management. Ultimately, a person with a poor track record of IT change management may become “Incarcerated” in jail, much like “Going Straight to Jail” in the game of Monopoly®. User administration screens could be created to set-up the incarceration rules (FIG. 5) and the rules for how an IT professional could be pardoned or freed from jail.

Another game allows the leading teams or leading point earners to obtain badges, special titles, or virtual currency. The virtual currency could be used to buy real goods, where the IT department subtracts the earned virtual currency for a prize—such as free dinner coupons or IT training vouchers. Other earned trinkets could include a “Get out of Jail Free Card” to be used if an IT Professional gets incarcerated.

I claim:

1. A method of promoting the use of business software, the method stored in memory and converts a general computing machine into a specific computing platform, that method comprising:
detecting that a user is interacting with a business software program;
in response to the interacting with the business software program, automatically directing the user to play a software game;
the game comprising a competitive activity involving knowledge, skill or chance;
at the conclusion of the game, directing the user back to the business software program.

2. The method of claim 1 wherein the business software is used to manage IT networks.

3. The method of claim 1 wherein the game does not violate the core values of the business.

4. The method of claim 1 wherein the game selects IT change records for special treatment as Red Pin changes.

5. The method of claim 4 wherein the game is unrelated to the task of managing IT networks.

6. The method of claim 4 wherein the automatic selection of Red Pin changes can be at random or on a defined frequency.

7. The method of claim 4 wherein users who complete the IT change are awarded or deducted points based on how well the IT change was completed.

8. The method of claim 4 wherein a ranking is shown that describes who are the points leaders.

9. The method of claim 1 wherein the game allows users to group themselves into competitive teams.

10. The method of claim 9 wherein the game allows users to define the rules team creation.

11. The method of claim 9 wherein the game allows users to define how long, as in weeks of time, a season of game play will continue.

12. The method of claim 9 wherein the game allows users to define how many teams will advance to head-to-head competition.

13. The method of claim 9 wherein the teams get collective points based on the individual points users are awarded or deducted based on how well these users complete IT changes.

14. The method of claim 9 wherein the game shows how the teams are ranked as the season of play evolves.

15. The method of claim 1 wherein the game provides teams and users virtual currency based on how well these users and teams complete IT changes.
